(19) United States
(12) Patent Application Publication
(10) Pub. No.: US 2026/0141078 A1
(43) Pub. Date: May 21, 2026

(54) Implementing Federal Information Processing Standards (FIPS) Compliance Checks Within the Software Development Process

(71) Applicant: Zscaler, Inc., San Jose, CA (US)

(72) Inventors: Romeo Gupta, Punjab (IN); Eric Terwilliger, Raleigh, NC (US); Ken Huie, San Jose, CA (US); Vidya Meenakshisundaram, San Jose, CA (US)

(73) Assignee: Zscaler, Inc., San Jose, CA (US)

(21) Appl. No.: 19/008,997

(22) Filed: Jan. 3, 2025

(30) Foreign Application Priority Data
Nov. 21, 2024 (IN) 202441090511

(51) Int. Cl. G06F 21/57; G06F 8/41; G06F 21/56; G06Q 10/0875

(52) U.S. Cl. CPC G06F 21/577; G06F 8/433; G06F 21/563; G06Q 10/0875

(57) ABSTRACT

Systems and methods for implementing a FIPS compliance check within the software development process include receiving a Software Bill of Materials (SBOM) associated with software in production; performing a vulnerability scan based on the SBOM; extracting a list of dependencies of the software based on the SBOM and generating a list of cryptographic dependencies associated with the software; and generating a FIPS compliance report for the software based on the vulnerability scan and the list of cryptographic dependencies.

### FIELD OF THE DISCLOSURE

The present disclosure generally relates to network and cloud security. More particularly, the present disclosure relates to systems and methods for implementing Federal Information Processing Standards (FIPS) compliance checks within the software development process.

### BACKGROUND OF THE DISCLOSURE

FIPS compliance checks ensure that software and systems meet U.S. government security requirements, especially for encryption and data protection. These checks are essential for organizations seeking FedRAMP authorization or working with government agencies. However, performing FIPS compliance checks can be challenging. Vendors typically conduct these checks during software delivery, limiting visibility and control for organizations relying on the results. If issues arise, they must be addressed within strict SLAs, which can be difficult without direct access to the original scans. Failure to meet compliance can lead to penalties, delays, increased costs, security risks, and loss of certifications, jeopardizing both regulatory standing and customer trust. Based thereon, the present disclosure provides a FIPS compliance system that is adapted to integrate within software development stages in order to eliminate these issues.

### BRIEF SUMMARY OF THE DISCLOSURE

The present disclosure relates to systems and methods for implementing FIPS compliance checks within the software development process. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include receiving a Software Bill of Materials (SBOM) associated with software in production; performing a vulnerability scan based on the SBOM; extracting a list of dependencies of the software based on the SBOM and generating a list of cryptographic dependencies associated with the software; and generating a FIPS compliance report for the software based on the vulnerability scan and the list of cryptographic dependencies.

The steps can further include retrieving source code of the software; and generating the SBOM based on the source code. The retrieving and generating can be performed automatically at one or more intervals during the development stage of the software. Generating the FIPS compliance report can be based on one or more rules. The vulnerability scan can include generating a vulnerability assessment report based on one or more rules, wherein the vulnerability assessment report is included in the FIPS compliance report. Generating a list of cryptographic dependencies can include finding potential cryptographic dependencies of the software based on the SBOM, comparing the potential cryptographic dependencies with approved cryptographic dependencies, and generating a cryptographic assessment report based thereon, wherein the cryptographic assessment report includes a list of cryptographic dependencies of the software with labels assigned thereto. Generating the cryptographic assessment report can include labeling any dependencies from the potential cryptographic dependencies of the software that are missing from the approved cryptographic dependencies as not a pre-approved dependency

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a flow diagram of a FIPS compliance system.

FIG. 6 is a flow diagram of the present FIPS compliance system having a FIPS scanner adapted to apply one or more rule sets.

FIG. 7 is a flowchart of a process for implementing FIPS compliance checks within the software development process.

### DETAILED DESCRIPTION OF THE DISCLOSURE

Again, the present disclosure relates to systems and methods for integrating autonomous Federal Information Processing Standards (FIPS) compliance checks into the software development process. Various embodiments implement a FIPS compliance system that is adapted to autonomously generate or retrieve SBOMs for performing compliance checks thereon. The generation or retrieval of SBOMs and performance of the checks can be performed automatically during various stages of the software development process. By doing so, vendors are not prone to issues that can result from performing FIPS compliance checks after a software package has been completed.

### § 1.0 Cybersecurity Monitoring and Protection Examples

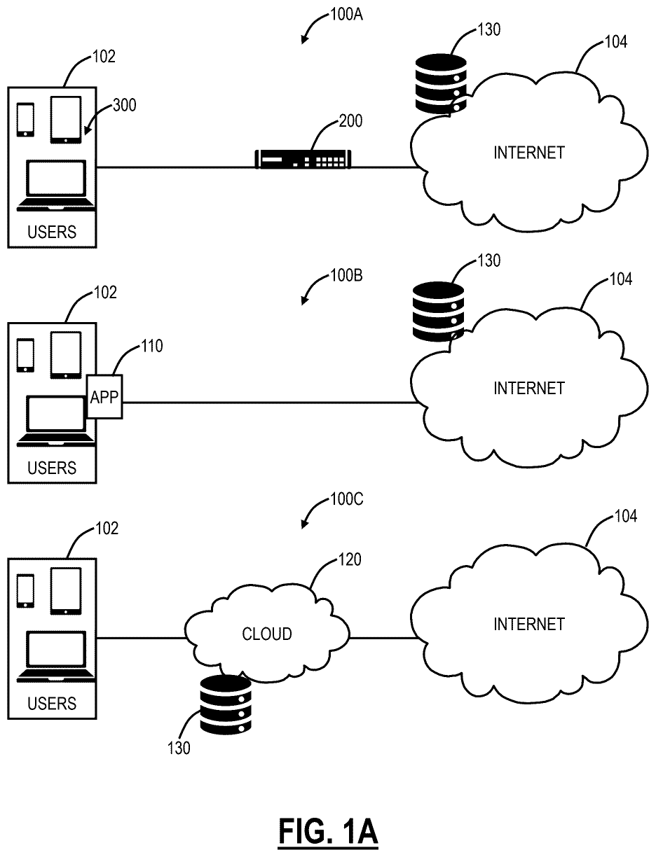

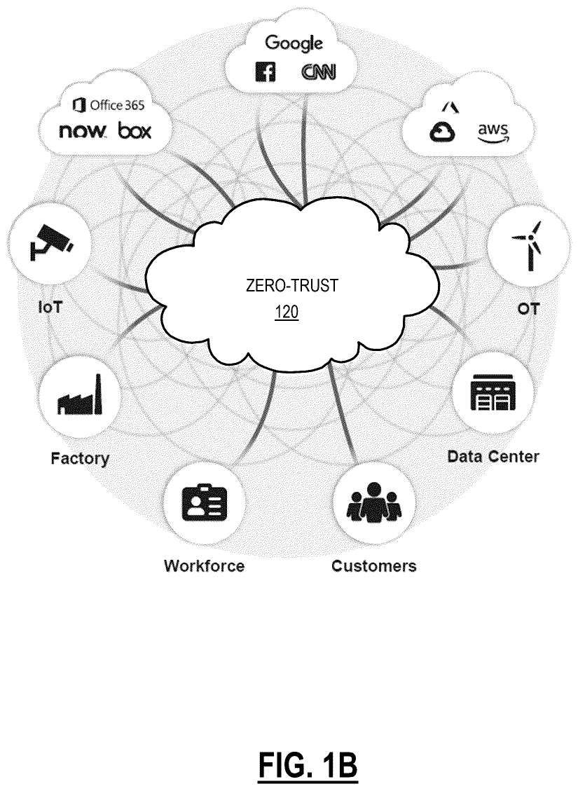

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

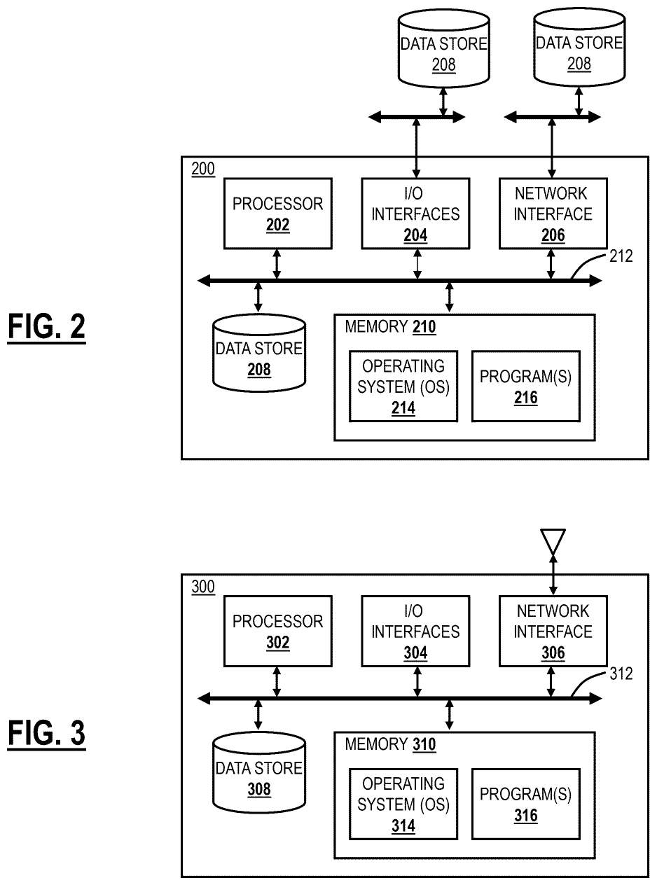

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:
Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.
Protect data using granular context-based policies: Zero trust policies verify access requests and rights based on context, including user identity, device, location, type of content, and the application being requested. Policies are adaptive, so user access privileges are continually reassessed as context changes.
Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:
Commonly-assigned U.S. Pat. No. 8,429,111, issued Apr. 23, 2013, and entitled “Encoding and compression of statistical data,” the contents of which are incorporated herein by reference, describes compression techniques for storing such logs,
Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and
Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc..

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

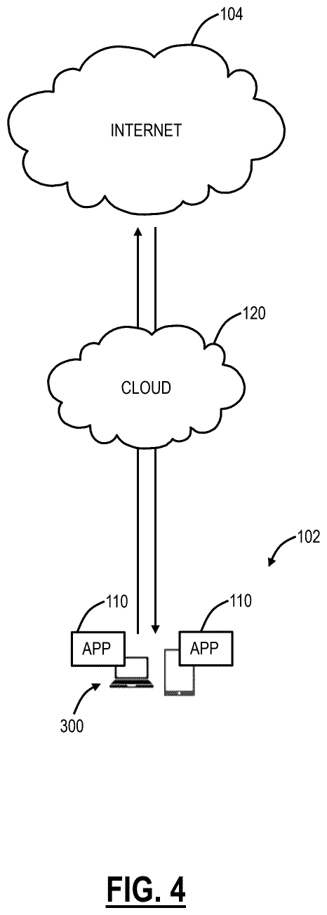

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 FIPS Compliance Checks

Integrating Federal Information Processing Standards (FIPS) compliance checks with the cloud 120 (cloud-based system) platform involves several key steps designed to ensure that security and regulatory standards are met across the entire software development lifecycle. Initially, a secure environment within the cloud 120 must be established where the FIPS compliance system, described later herein, can operate. This setup includes configuring necessary virtual machines, containers, or serverless functions to host the FIPS scanning tools associated with the FIPS compliance system. Robust access control measures must be implemented to ensure that only authorized personnel and systems can interact with the FIPS compliance system, leveraging the cloud 120 identity and access management features.

Additional steps involve integrating the FIPS compliance system directly into the cloud 120 CI/CD pipelines. This can be achieved by adding stages in the pipeline scripts (e.g., Jenkins, GitLab CI, CircleCI) that trigger FIPS scans. Additionally, these scans can be performed autonomously by the FIPS compliance system based on time intervals, at preconfigured stages, etc. Automated tasks within the CI/CD pipeline can be set up to generate the Software Bill of Materials (SBOM) if it is not already available. These scans can be triggered at key stages, such as after code commits, during builds, and before deployment to production. Real-time reporting features are integrated to provide immediate feedback on compliance status, enabling development teams to quickly address any issues identified.

The FIPS compliance system extracts a list of dependencies and their respective versions from the SBOM and compare these dependencies against an internal database of approved cryptographic modules provided by a federal compliance team. This analysis ensures that only FIPS-approved cryptographic libraries are used. Detailed compliance reports are generated and accessed by development, security, and compliance teams. These reports highlight approved and non-approved dependencies, along with recommended actions for non-compliant components. A review process is facilitated where compliance reports are assessed by relevant stakeholders, including the development team, security team, and compliance officers.

Automated remediation scripts can be implemented within the cloud 120 environment to take predefined actions based on FIPS compliance scan results, such as blocking deployments that fail compliance checks or automatically upgrading non-compliant dependencies. The cloud's policy enforcement capabilities are be used to ensure that only FIPS-compliant software is deployed across the cloud infrastructure, including setting up policies that enforce encryption standards and secure communication protocols. Continuous monitoring tools are integrated within the cloud 120 to ensure ongoing compliance with FIPS standards, including regular scans of deployed applications and their dependencies. Detailed audit trails of all compliance checks, scans, and remediation actions are maintained, as these logs are crucial for regulatory audits and internal reviews.

Although, various embodiments described herein reference the FIPS compliance system with the cloud 120, it shall be noted that the present FIPS compliance system can be implemented within any software development lifecycle for ensuring compliance.

### § 5.1 FIPS Compliance System

The present disclosure relates to systems and methods for integrating autonomous Federal Information Processing Standards (FIPS) compliance checks into the software development process. Today, vendors perform FIPS-related checks at the time of software delivery, but do not have direct access to these scans and checks. In the event of any failure, they will be required to address the findings and reported issues within strict SLAs. Failure to meet these requirements could result in several serious consequences, including penalties, risks to FedRAMP authorization and other government-issued certifications, and potential security vulnerabilities. Additionally, it could lead to increased regulatory challenges, project delays, rework, and the need for retesting. These setbacks may also result in a loss of trust, higher costs, and customer dissatisfaction, all of which could significantly impact the success and reputation of the project. Based thereon, the present FIPS compliance system is adapted to perform associated checks during the software development stage, allowing developers to deliver more secure and compliant software with early detection.

The Federal Information Processing Standards (FIPS) of the United States represent a collection of publicly announced standards created by the National Institute of Standards and Technology (NIST). These standards are specifically designed for implementation within computer systems used by non-military United States government agencies and their contractors. The primary goal of FIPS is to ensure the security and interoperability of systems and data across these entities. FIPS encompasses several critical areas, including data encryption, which outlines specific standards for protecting sensitive information. This includes protocols and algorithms that must be employed to ensure data is securely encrypted both at rest and in transit, safeguarding it from unauthorized access and breaches.

Additionally, the standards specify approved cryptographic algorithms that can be used for various security functions. These algorithms are rigorously tested and validated by NIST to ensure they meet stringent security requirements. Examples include the Advanced Encryption Standard (AES) and the Secure Hash Algorithm (SHA) family. Adherence to FIPS is mandatory for federal agencies and their contractors, ensuring that all implemented security measures meet a baseline level of protection as defined by the standards. This is crucial for maintaining the integrity and confidentiality of government data.

Furthermore, FIPS promotes interoperability between different systems and organizations. By standardizing security protocols and procedures, FIPS ensures that systems can communicate securely and effectively with each other, fostering a cohesive and collaborative environment across various government agencies and their partners. Overall, FIPS plays a vital role in maintaining the security, reliability, and cohesion of information systems used by the U.S. government. Through these standards, NIST provides a robust framework to protect sensitive data and ensure seamless interaction between governmental and contractor systems.

FIPS scans are a mandatory requirement under the Federal Risk and Authorization Management Program (FedRAMP). Currently, these compliance checks are conducted by external vendors during the software delivery phase. Currently, software providers do not have direct access to these scans. This lack of early visibility poses significant risks. For example, if the software fails compliance checks late in the process, it can lead to a host of detrimental consequences.

First and foremost, project timelines can be severely impacted, resulting in substantial delays. This necessitates rework and retesting to address compliance issues, which can consume valuable time and resources. Furthermore, such setbacks can erode trust between stakeholders, including customers and partners, potentially damaging reputations. Non-compliance can also result in financial repercussions, including penalties and increased project costs due to the need for additional remediation efforts. From a security standpoint, undetected issues pose significant risks, potentially exposing vulnerabilities that could be exploited by malicious actors. This not only jeopardizes the integrity and security of the software but also leads to customer dissatisfaction due to unmet security expectations.

Moreover, failing to meet FedRAMP and FIPS requirements can result in regulatory issues, complicating the ability to operate within certain markets or sectors. This can further exacerbate the financial and reputational impact, making it imperative to integrate FIPS compliance checks earlier in the software development lifecycle to mitigate these risks. By adopting a proactive approach and incorporating FIPS scans throughout the development process, software providers can minimize the likelihood of these adverse outcomes, ensuring smoother project execution, enhanced security, and greater customer satisfaction.

To enhance security posture and ensure FIPS compliance, the present disclosure provides systems and methods for integrating FIPS scans and related compliance checks into the software development lifecycle and Continuous Integration/Continuous Deployment (CI/CD) pipelines. The goal is to embed these scans at multiple stages of the lifecycle, starting from the earliest phases of development through deployment. Initially, the scans are conducted during the deployment phase, focusing on testing and verification across various environments to capture real-time software runtime checks. However, to adopt a more proactive compliance strategy, the present systems aim to “shift left” by integrating these scans as early as possible, beginning directly at the source code level.

The present FIPS compliance system encompasses several key areas including source code and dependencies, infrastructure, configuration and communication, and container images. For the source code and dependencies, the process includes performing static code analysis to identify vulnerabilities or non-compliance issues, ensuring all third-party libraries and modules adhere to FIPS standards. In terms of infrastructure, the systems scan servers, network configurations, and storage systems, implementing security controls and compliance checks within Infrastructure-as-Code (IaC) templates. For configuration and communication, the process includes reviewing and analyzing configuration files and communication protocols to ensure FIPS compliance and that all data in transit is encrypted using FIPS-approved cryptographic algorithms. Container images undergo thorough scans to detect non-compliant components or configurations, with FIPS compliance checks integrated into the container build process to address issues before deployment.

To implement this strategy, the process incorporates FIPS compliance scans into the CI/CD pipelines, starting from the source code repository and using automated tools for performing continuous scans and generating compliance reports. During the deployment phase, additional runtime scans are conducted to verify secure operation in various environments, addressing any compliance issues that arise during testing and verification. Regular updates to scanning tools and compliance databases will reflect the latest FIPS standards, supported by periodic audits to ensure ongoing adherence. Furthermore, the systems provide training for development and operations teams on FIPS compliance best practices, fostering a culture of security and compliance within organizations.

By adopting this comprehensive approach, the present systems can ensure software not only meets FIPS compliance standards but also maintains a robust security posture throughout its lifecycle.

Conducting FIPS scans at the source code level, particularly for dependencies, offers several critical advantages that can significantly benefit the software development lifecycle. This approach promotes the creation of awareness among development teams, ensuring that they are cognizant of compliance requirements from the very beginning. By integrating these scans early in the process, the present systems can achieve effective compliance verification, ensuring that all code and dependencies adhere to FIPS standards before they progress further in the development pipeline.

One of the most significant benefits of early FIPS scans is the early detection of issues. Identifying potential vulnerabilities and non-compliant cryptographic libraries at the source code stage allows for prompt remediation, reducing the risk of encountering more severe problems later in the development lifecycle. This proactive approach helps avoid costly and time-consuming rework, retesting, and delays that can arise from late-stage compliance failures.

Furthermore, implementing FIPS scans at the source code level helps establish trust and security assurance for stakeholders. By directly scanning the source code of the application and leveraging a Bill of Materials (BOM), the systems can provide a transparent and comprehensive view of all dependencies and their compliance status. This transparency fosters confidence among stakeholders, including customers, partners, and regulatory bodies, by demonstrating the commitment to robust security practices and adherence to compliance standards.

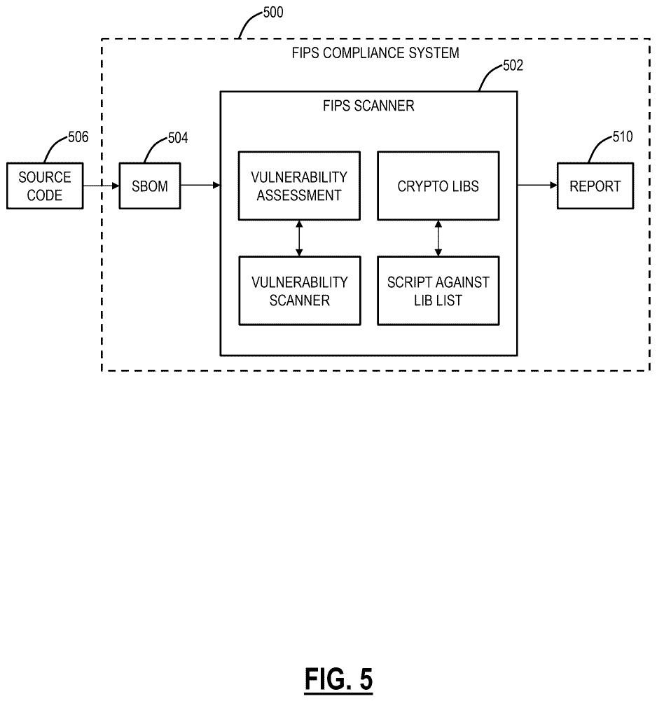

FIG. 5 is a flow diagram of a FIPS compliance system 500. In various embodiments, the FIPS compliance system 500 includes a design workflow beginning with a FIPS scanner 502 inputting the Software Bill of Materials (SBOM) 504 if it is already available. If the SBOM 504 is not available, the FIPS scanner 502 will require access to the repository source code 506 to generate the SBOM 504. In such cases, the FIPS scanner 502 will generate the SBOM 504 from the source code 506. Once the SBOM 504 is in place, the FIPS scanner 502 will conduct open-source vulnerability scanning on the SBOM 504, producing a vulnerability findings report. Again, the present FIPS compliance system 500 can perform its various functions autonomously during the development stages of software. That is, the FIPS compliance system 500 can generate SBOMs to generate reports at various points in the software development lifecycle.

Next, the FIPS scanner 502 will extract a list of dependencies and their respective versions from the SBOM 504. It will then compare this list against an internal database of cryptographic dependencies and keywords to generate a cryptographic dependencies references list. This list is crucial as it identifies the cryptographic components within the software.

The FIPS scanner 502 will subsequently check the cryptographic dependencies references list against a pre-approved list of dependencies provided by a federal compliance team. If a dependency from the cryptographic dependencies references list exists in the pre-approved list, the scanner will update the report to mark it as approved and mention its inclusion in the pre-approved list. Conversely, if a dependency is missing from the pre-approved list, the scanner will update the report to note it as not approved and request further review from the development and security teams. The report can be contemplated as a FIPS compliance report 510 that represents the software's overall FIPS compliance.

This detailed and systematic workflow ensures comprehensive scanning and compliance verification, starting from the generation and analysis of the SBOM 504 to the final approval or request for further review of cryptographic dependencies. By following this approach, the FIPS scanner 502 facilitates early detection of vulnerabilities and compliance issues, thereby enhancing the overall security and reliability of the software.

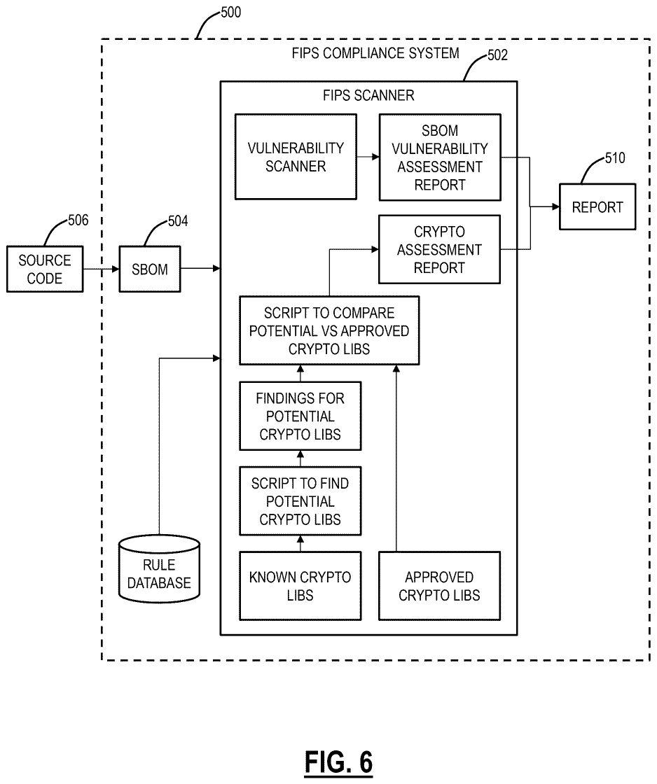

In various embodiments, the FIPS scan is added as a scanning stage where it directly scans the SBOM of an application if it exists or it will generate the SBOM from source code and then perform a scan to apply rules, detect potential vulnerabilities and crypto libraries. FIG. 6 is a flow diagram of the present FIPS compliance system having a FIPS scanner adapted to apply one or more rule sets. Again, the CI scan workflow for FIPS compliance begins with input acquisition, where the FIPS scanner 502 will take the SBOM 504 as input if it is already available. If the SBOM 504 is not available, the FIPS scanner 502 will require access to the source code repository to generate the SBOM 504. In cases where the SBOM 504 is absent, the FIPS scanner 502 can employ open-source third-party tools such as Anchore or Syft to generate the SBOM 504 from the source code 506.

Following the SBOM 504 generation, the FIPS scanner 502 will perform a Software Composition Analysis (SCA) scan on the SBOM 504. This process will generate detailed vulnerability reports, which are crucial for identifying and mitigating potential security risks. Subsequently, the FIPS scanner 502 will extract a comprehensive list of dependencies and their respective versions from the SBOM 504. To generate a compliance report, the FIPS scanner 502 will apply a predefined set of rules to the SBOM 504. These rules are defined in JSON format within a FIPS scanner ruleset source code repository. The build process for the repository generates a rules file and publishes it to a rule database 508. During the scan, the FIPS scanner 502 will import the rules file from the rule database 508. Each ruleset version has a defined tool-compatible version, and in cases of incompatibility between the tool and the ruleset version, the tool will recommend using a different version.

A default rule for the FIPS scanner 502 includes comparing the extracted list of dependencies with an internal store of commonly known cryptographic libraries and matching dependency naming patterns. The FIPS scanner 502 will then compare the detected cryptographic dependencies of the software with a pre-approved list of dependencies provided by the federal compliance team. If any dependency from the detected cryptographic dependencies list also exists in the pre-approved list, it will be recorded as an approved library in the report, referencing the pre-approved list. Conversely, if any dependency from the detected cryptographic dependencies list is missing from the pre-approved list, it will be recorded as not a pre-approved library in the report, with a comment indicating that further review is required from the development and security teams.

Additionally, the FIPS scanner 502 has the capability to ingest and scan multiple SBOMs 504 against any ruleset. For example, a rule can cause the FIPS compliance system 500 to verify a library version in the SBOM. Thus, if a new version of OpenSSL is available from SafeLogic, the scanner will check the SBOM 504 and, if it detects an older version of OpenSSL, it will suggest an upgrade to the current version from the approved list in the FIPS compliance report 510. By adhering to this comprehensive scan workflow, the FIPS compliance system 500 ensures thorough compliance checks, vulnerability detection, and adherence to predefined rules, thereby enhancing the overall security and reliability of the software throughout its development lifecycle. § 5.2 Process for Implementing FIPS Compliance Checks Within the Software Development Lifecycle

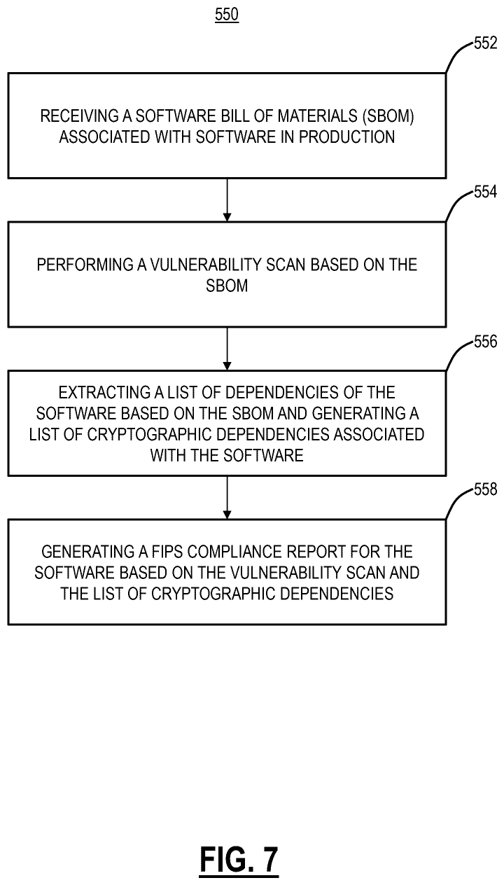

FIG. 7 is a flowchart of a process for implementing a FIPS compliance check within the software development process. In various embodiments, the process 550 can be contemplated as a method having steps, a processing device configured to implement the steps, a cloud-based system configured to implement the steps, as a non-transitory computer-readable medium storing instructions for programming one or more processors to execute the steps, and as a FIPS compliance system. The process 550 includes receiving a Software Bill of Materials (SBOM) associated with software in production (step 552); performing a vulnerability scan based on the SBOM (step 554); extracting a list of dependencies of the software based on the SBOM and generating a list of cryptographic dependencies associated with the software (step 556); and generating a FIPS compliance report for the software based on the vulnerability scan and the list of cryptographic dependencies (step 558).

The process 550 can further include retrieving source code of the software; and generating the SBOM based on the source code. The retrieving and generating can be performed automatically at one or more intervals during the development stage of the software. Generating the FIPS compliance report can be based on one or more rules. The vulnerability scan can include generating a vulnerability assessment report based on one or more rules, wherein the vulnerability assessment report is included in the FIPS compliance report. Generating a list of cryptographic dependencies can include finding potential cryptographic dependencies of the software based on the SBOM, comparing the potential cryptographic dependencies with approved cryptographic dependencies, and generating a cryptographic assessment report based thereon, wherein the cryptographic assessment report includes a list of cryptographic dependencies of the software with labels assigned thereto. Generating the cryptographic assessment report can include labeling any dependencies from the potential cryptographic dependencies of the software that are missing from the approved cryptographic dependencies as not a pre-approved dependency

### § 6.0 Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 7.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method for implementing a Federal Information Processing Standards (FIPS) compliance check, the method comprising steps of:
receiving a Software Bill of Materials (SBOM) associated with software in production;
performing a vulnerability scan based on the SBOM;
extracting a list of dependencies of the software based on the SBOM and generating a list of cryptographic dependencies associated with the software; and
generating a FIPS compliance report for the software based on the vulnerability scan and the list of cryptographic dependencies.

2. The method of claim 1, wherein the steps comprise:
retrieving source code of the software; and
generating the SBOM based on the source code.

3. The method of claim 2, wherein the retrieving and generating are performed automatically at one or more intervals during a development stage of the software.

4. The method of claim 1, wherein generating the FIPS compliance report is based on one or more rules.

5. The method of claim 1, wherein the vulnerability scan includes generating a vulnerability assessment report based on one or more rules, and wherein the vulnerability assessment report is included in the FIPS compliance report.

6. The method of claim 1, wherein generating a list of cryptographic dependencies includes finding potential cryptographic dependencies of the software based on the SBOM, comparing the potential cryptographic dependencies with approved cryptographic dependencies, and generating a cryptographic assessment report based thereon, and wherein the cryptographic assessment report includes a list of cryptographic dependencies of the software with labels assigned thereto.

7. The method of claim 6, wherein generating the cryptographic assessment report includes labeling any dependencies from the potential cryptographic dependencies of the software that are missing from the approved cryptographic dependencies as not a pre-approved dependency.

8. A non-transitory computer-readable medium comprising instructions for implementing a Federal Information Processing Standards (FIPS) compliance check that, when executed, cause one or more processors to perform steps of:
receiving a Software Bill of Materials (SBOM) associated with software in production;
performing a vulnerability scan based on the SBOM;
extracting a list of dependencies of the software based on the SBOM and generating a list of cryptographic dependencies associated with the software; and
generating a FIPS compliance report for the software based on the vulnerability scan and the list of cryptographic dependencies.

9. The non-transitory computer-readable medium of claim 8, wherein the steps comprise:
retrieving source code of the software; and
generating the SBOM based on the source code.

10. The non-transitory computer-readable medium of claim 9, wherein the retrieving and generating are performed automatically at one or more intervals during a development stage of the software.

11. The non-transitory computer-readable medium of claim 8, wherein generating the FIPS compliance report is based on one or more rules.

12. The non-transitory computer-readable medium of claim 8, wherein the vulnerability scan includes generating a vulnerability assessment report based on one or more rules, and wherein the vulnerability assessment report is included in the FIPS compliance report.

13. The non-transitory computer-readable medium of claim 8, wherein generating a list of cryptographic dependencies includes finding potential cryptographic dependencies of the software based on the SBOM, comparing the potential cryptographic dependencies with approved cryptographic dependencies, and generating a cryptographic assessment report based thereon, and wherein the cryptographic assessment report includes a list of cryptographic dependencies of the software with labels assigned thereto.

14. The non-transitory computer-readable medium of claim 13, wherein generating the cryptographic assessment report includes labeling any dependencies from the potential cryptographic dependencies of the software that are missing from the approved cryptographic dependencies as not a pre-approved dependency.

15. A cloud-based system comprising:
one or more processors; and
memory storing computer-executable instructions that, when executed, cause the one or more processors to:
receive a Software Bill of Materials (SBOM) associated with software in production;
perform a vulnerability scan based on the SBOM;
extract a list of dependencies of the software based on the SBOM and generate a list of cryptographic dependencies associated with the software; and
generate a FIPS compliance report for the software based on the vulnerability scan and the list of cryptographic dependencies.

16. The cloud-based system of claim 15, wherein the instructions, when executed, further cause the one or more processors to:
retrieve source code of the software; and
generate the SBOM based on the source code.

17. The cloud-based system of claim 16, wherein the retrieving and generating are performed automatically at one or more intervals during a development stage of the software.

18. The cloud-based system of claim 15, wherein generating the FIPS compliance report is based on one or more rules.

19. The cloud-based system of claim 15, wherein the vulnerability scan includes generating a vulnerability assessment report based on one or more rules, and wherein the vulnerability assessment report is included in the FIPS compliance report.

20. The cloud-based system of claim 15, wherein generating a list of cryptographic dependencies includes finding potential cryptographic dependencies of the software based on the SBOM, comparing the potential cryptographic dependencies with approved cryptographic dependencies, and generating a cryptographic assessment report based thereon, and wherein the cryptographic assessment report includes a list of cryptographic dependencies of the software with labels assigned thereto.
